(19) United States
(12) Patent Application Publication
(10) Pub. No.: US 2011/0108010 A1
(43) Pub. Date: May 12, 2011

(54) Fuel Vaporizing Device for Motor Vehicles and Method Therefor

(75) Inventor: Jerry J. Alvarez, Surprise, AZ (US)

(73) Assignee: AEDC ALTERNATIVE ENERGY DEVELOPMENT CORPORATION, Glendale, AZ (US)

(21) Appl. No.: 12/628,378

(22) Filed: Dec. 1, 2009

Related U.S. Application Data
(60) Provisional application No. 61/260,730, filed on Nov. 12, 2009.

(51) Int. Cl. F02G 5/00; F02M 29/00; B21D 53/02

(52) U.S. Cl. 123/556; 123/590; 29/890.03

(57) ABSTRACT

A fuel vaporizing device has a body with a fuel inlet, air inlet, and vapor outlet. A spiral conduit is formed in the body with a length of 2-6 feet. The spiral conduit has a first end coupled to the air inlet and second end coupled to the vapor outlet. An injector assembly is disposed within the body and coupled to the fuel inlet. The injector assembly introduces atomized fuel into the first end of the spiral conduit. The fuel and air mixture is converted to vaporized fuel through a length of the spiral conduit. The vaporized fuel exits at the vapor outlet. The injector assembly has a compression spring disposed in a cavity of an injector body. An injector piston is disposed in the cavity of the injector body contacting the spring. An injector outlet introduces the atomized fuel into the spiral conduit when the injector piston is displaced.

### CLAIM TO DOMESTIC PRIORITY

The present non-provisional patent application claims the benefit of priority of provisional application Ser. No. 61/260,730 entitled “Fuel Conserving Device and Method,” filed Nov. 12, 2009.

### FIELD OF THE INVENTION

The present invention relates in general to motor vehicles and, more specifically, to a fuel vaporizing device for use with a motor vehicle.

### BACKGROUND OF THE INVENTION

Motor vehicles are commonly used for daily personal and business transportation purposes. Motor vehicles include autos, vans, trucks, motorcycles, all terrain vehicles (ATV), marine, and aviation. The typical motor vehicle operates with an internal combustion engine. Fuel (gasoline) is stored in a tank in a fluid state and pumped to a carburetor or fuel injection system on demand, where the fuel is atomized and mixed with air. The fuel and air mixture is routed through intake valves to the internal cylinders of the engine. The fuel and air mixture is compressed and then ignited by a spark plug causing combustion within the cylinder. The combustion creates an expansion of high temperature gases under pressure to force a piston within the cylinder downward. Most engines have 2-12 cylinders and associated pistons. The pistons are coupled to a crankshaft which rotates with each downward thrust of the pistons following cylinder combustion. The crankshaft turns gears or bands within a transmission which in turn rotates a drive shaft. The drive shaft turns the wheels, in some cases through a rear differential gear, to move the auto along a roadway.

The motor vehicle consumes an amount of fuel over a distance depending on the engine size, vehicle load, engine calibration, driving conditions, speed, and other factors. The fuel consumption is typically measured in terms of miles per gallon or liters per kilometer. Optimizing fuel consumption is important in terms of economic efficiency, i.e., minimizing cost of operating the motor vehicle, as well as reducing emission of harmful gases created by the combustion process and reducing overall consumption of a non-renewable natural resource (gasoline).

One of the factors affecting fuel consumption is the physical state of the fuel entering the cylinder. Ideally, the fuel should be completely vaporized when entering the cylinder. The higher the percent of fuel that is vaporized, the more energy that can be extracted per unit of fuel by the combustion process. However, in most if not all carburetor and fuel injection systems, a substantial portion of the atomized fuel is not vaporized. The non-vaporized portion of the fuel does not contribute to the energy conversion process and is therefore wasted potential energy. Consequently, more fuel is required during combustion to generate the requisite energy needed to propel the motor vehicle under the instant operating conditions. The non-vaporized fuel is expelled with the exhausted gas following combustion resulting in lower fuel economy, higher cost in operating the motor vehicle, greater harmful gas emission such as hydrocarbons and carbon monoxide, and inefficient use of the non-renewable natural resource.

### SUMMARY OF THE INVENTION

A need exists to improve the fuel economy in motor vehicles by vaporizing a greater percentage of the fuel for combustion in the engine cylinder. Accordingly, in one embodiment, the present invention is a fuel vaporizing device comprising a body having a fuel inlet, air inlet, and vapor outlet. A spiral conduit is formed in the body. The spiral conduit has a first end coupled to the air inlet and second end coupled to the vapor outlet. An injector assembly is disposed within the body and coupled to the fuel inlet. The atomized fuel is converted to vaporized fuel through a length of the spiral conduit from the first end to the second end of the spiral conduit. The vaporized fuel exits the body at the vapor outlet.

In another embodiment, the present invention is a fuel vaporizing device comprising a body having a fuel inlet, air inlet, and vapor outlet. A conduit is formed in the body. The conduit has a first end coupled to the air inlet and second end coupled to the vapor outlet. An injector assembly is disposed within the body and coupled to the fuel inlet. The injector assembly introduces atomized fuel into the first end of the conduit. The atomized fuel is converted to vaporized fuel through a length of the conduit from the first end to the second end of the conduit. The vaporized fuel exits the body at the vapor outlet.

In another embodiment, the present invention is a fuel vaporizing device comprising a body having a fuel inlet, air inlet, and vapor outlet. A conduit is formed in the body. The conduit has a first end coupled to the air inlet and second end coupled to the outlet. Fuel is introduced into the first end of the conduit and converted to vaporized fuel through a length of the conduit. The vaporized fuel exits the body at the vapor outlet.

In another embodiment, the present invention is a method of making a fuel vaporizing device comprising the steps of forming a body having a fuel inlet, air inlet, and vapor outlet, and forming a conduit in the body. The conduit has a first end coupled to the air inlet and second end coupled to the vapor outlet. The method further includes the step of disposing an injector assembly within the body and coupled to the fuel inlet. The injector assembly introduces atomized fuel into the first end of the conduit. The atomized fuel is converted to vaporized fuel through a length of the conduit from the first end to the second end of the conduit. The vaporized fuel exits the body at the vapor outlet.

### BRIEF DESCRIPTION OF THE DRAWINGS

FIG. 1 illustrates a motor vehicle with fuel vaporizing device mounted in the engine compartment;

FIG. 2 is a block diagram of the fuel and air intake system using the fuel vaporizing device;

FIG. 3 illustrates the molded body and fittings of the fuel vaporizing device;

FIG. 4 illustrates a cross-sectional view of the fuel vaporizing device with interior injector body and spiral conduit;

FIG. 5 illustrates a cutaway view of the fuel vaporizing device showing the interior injector body and spiral conduit;

FIG. 6 illustrates an exploded, perspective view of components of the fuel vaporizing device;

FIGS. 7A-7B illustrate further detail of the injector body and spring piston assembly;

FIG. 8 illustrates the fuel vaporizing device implemented with a conduit formed from circular paths interconnected on alternating sides of the molded body;

FIG. 9 illustrates the fuel vaporizing device implemented with a serpentine conduit; and

FIG. 10 illustrates the fuel vaporizing device implemented with a variable length serpentine conduit selectable by opening and closing gates.

### DETAILED DESCRIPTION OF EMBODIMENTS OF THE INVENTION

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

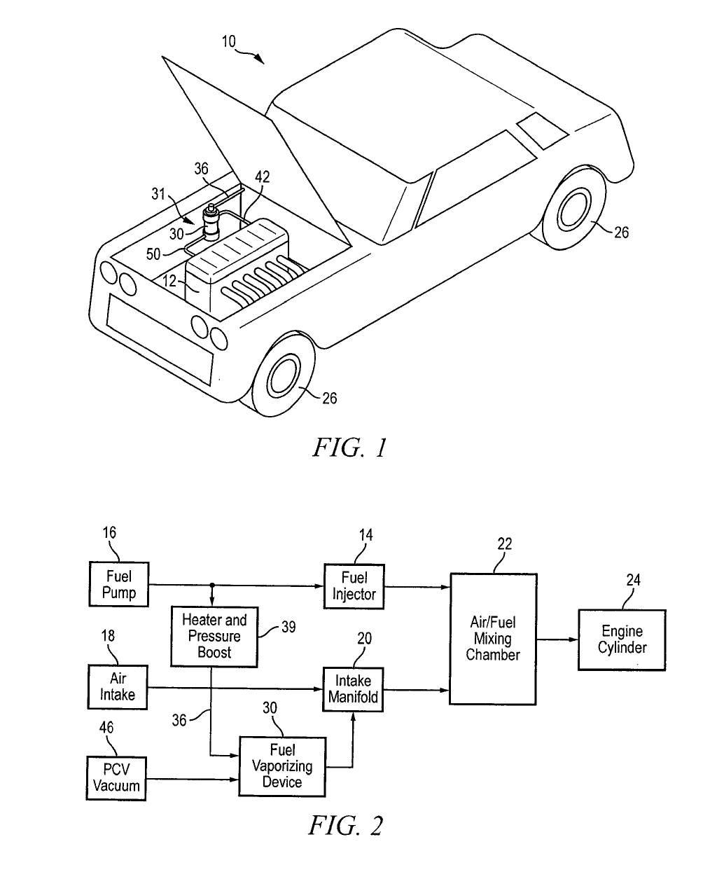

Motor vehicles are commonly used for daily personal and business transportation purposes. Motor vehicles include autos, vans, trucks, motorcycles, ATVs, marine, and aviation. The motor vehicle operates with an internal combustion engine. FIG. 1 illustrates auto 10 with internal combustion engine 12. Fuel (gasoline) is stored in a tank in a fluid state and pumped to a carburetor or fuel injection system 14 by fuel pump 16 under pressure of 7-60 pounds per square inch (PSI), as shown in FIG. 2. In one embodiment, the fuel pressure is 40 PSI. Fuel injector 14 atomizes a portion of the fluid-state fuel, i.e., creates micro-size droplets. However, fuel injector 14 does not vaporize the fluid-state fuel. The outside air is drawn into air intake 18 and routed to intake manifold 20. The intake manifold 20 evenly distributes the air to each intake port in the cylinder heads. The atomized air and fuel are mixed together in air-fuel mixing chamber 22 within the intake port in the cylinder heads. The air-fuel vapor mixture is routed through intake valves to internal cylinders 24 of the engine. The fuel and air mixture is compressed and then ignited by a spark plug causing combustion within cylinder 24. The combustion creates an expansion of high temperature gases under pressure to force a piston within the cylinder downward. Most engines have 2-12 cylinders and associated pistons. The pistons are coupled to a crankshaft which rotates with each downward thrust of the pistons following cylinder combustion. The crankshaft turns gears or bands within a transmission which in turn rotates a drive shaft. The drive shaft turns wheels 26, in some cases through a rear differential gear, to move auto 10 along a roadway.

The motor vehicle consumes an amount of fuel over a distance depending on the engine size, vehicle load, engine calibration, driving conditions, speed, and other factors. The fuel consumption is typically measured in terms of miles per gallon or liters per kilometer. Optimizing fuel consumption is important in terms of economic efficiency, i.e., minimizing cost of operating the motor vehicle, as well as reducing emission of harmful gases created by the combustion process and reducing overall consumption of a non-renewable natural resource.

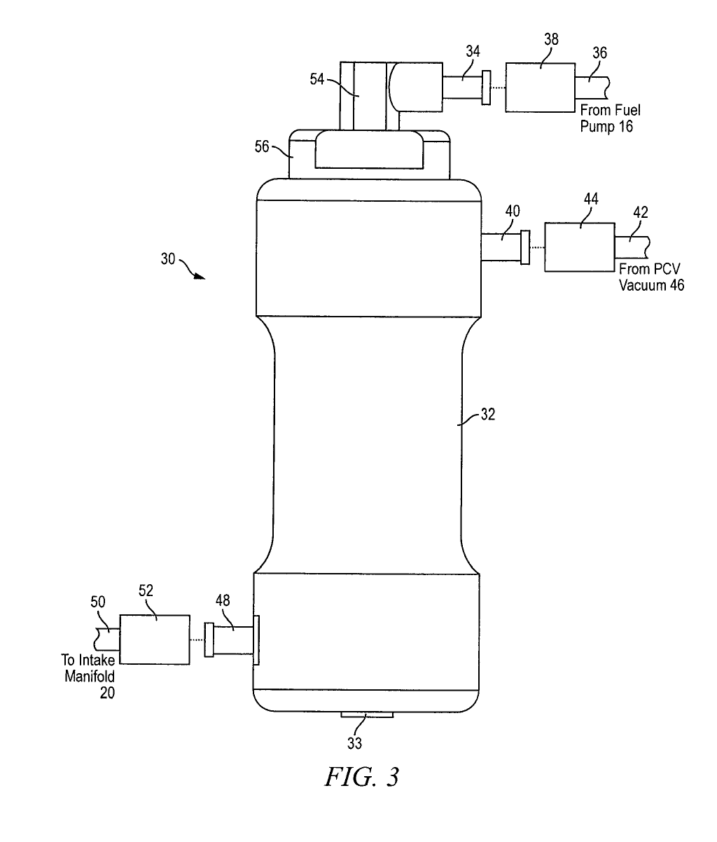

To improve fuel economy, a fuel vaporizing device 30 is mounted within engine compartment 31 of auto 10 with a bracket or other suitable fastener. FIG. 3 shows an exterior view of fuel vaporizing device 30. Fuel vaporizing device 30 has an injection molded cylindrical body 32 made with a rigid, heat resistant polymer material, such a tetrafluoroethylene, perfluoroamide-aziridine polymer, perfluoroalkanoyl-substituted poly(ethyleneimine), or other fluorine-containing polymer. The molded body 32 includes service port 33 for removing fuel contaminants.

The molded body 32 has three fittings for fuel inlet, air inlet, and vaporized fuel outlet. A fitting 34, e.g., SAE J2044 type fitting designed for factory specified fuel lines, is coupled to hose 36 with SAE J2044 hose clamp 38. The SAE J2044 clamp and fitting simplifies the installation process and provides a leak-proof connection. Hose 36 is connected to the fuel line coming from fuel pump 16. An optional fuel heater and pressure boost 39 can be installed prior to fitting 34. A fitting 40 is coupled to hose 42 with hose clamp 44. Hose 42 is connected to vacuum line 46. In one embodiment, hose 42 is connected to positive crankcase ventilation (PCV) vacuum drawn from the valve cover of engine 12. Hose 42 can also be connected to other vehicle vacuum lines having a minimum pressure of 10 PSI (preferably 15-20 PSI) during idle. A fitting 48 is coupled to hose 50 with hose clamp 52. Hose 50 is connected to intake manifold 20, as shown in FIG. 2.

Fuel vaporizing device 30 receives fuel in fluid state from the fuel line, vaporizes the fuel, and feeds the vaporized fuel into the air mixture within intake manifold 20. The vaporized fuel is routed to engine cylinder 24 for combustion. A sensor in the exhaust manifold detects the additional fuel from air-fuel ratio. The engine controller cuts back on the fuel supplied by fuel injector 14 (because of the vaporized fuel supplied from the intake manifold) to maintain the necessary air-fuel mixture ratio, say 12:1. The vaporized fuel-air mixture coming from intake manifold 20 readily combusts within engine cylinder 24 to increase the percentage of fuel converted to actual work product and reduces the fuel supplied by fuel injector 14. Since fuel injector 14 does not vaporize the fuel, the more fuel that can be supplied by fuel vaporizing device 30, the higher the combustion efficiency and greater the fuel economy.

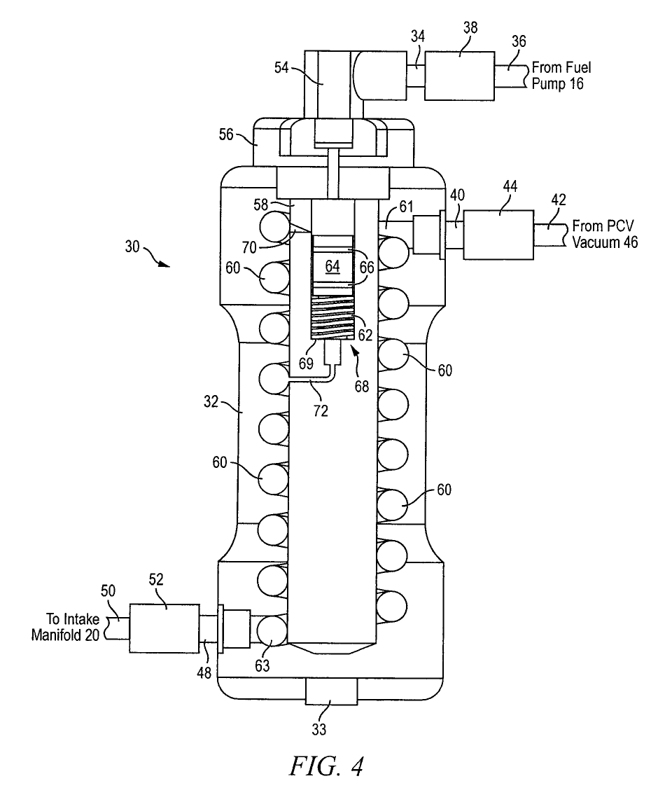

A cross-sectional view of fuel vaporizing device 30 is shown in FIG. 4. The fluid-state fuel from fuel pump 16 enters through fitting 34 at 40 PSI and is directed through right-angle coupling 54 and body cap 56 to injector body 58. The right-angle coupling 54 contains a flow reduction needle valve for maintaining pressure while restricting volume. The high pressure low volume (HPLV) bi-directional flow control provides precision fuel flow adjustment for control and tuning of fuel vaporizing device 30 while maintaining sufficient fuel pressure for atomization.

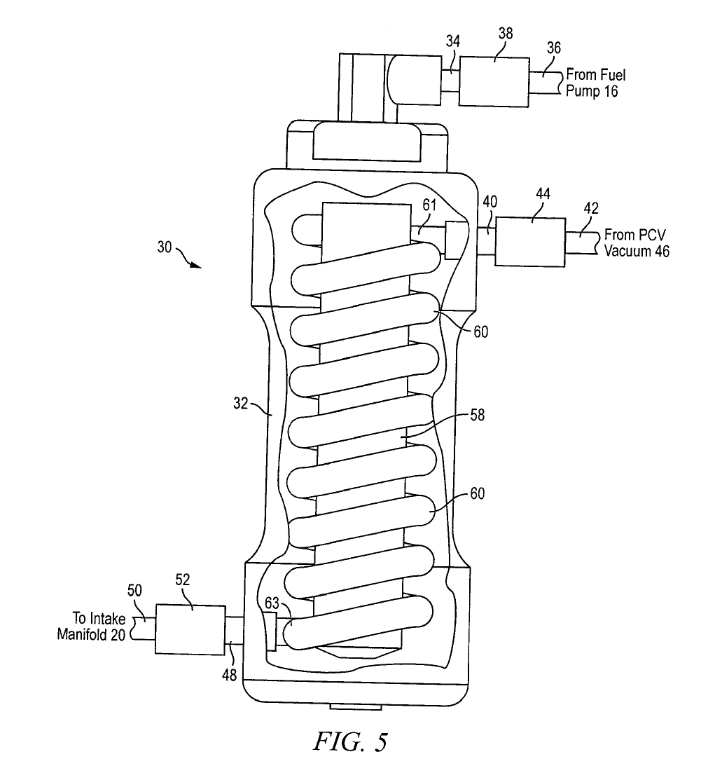

A spiral chamber or conduit 60 is formed into the molded body 32. The length of spiral conduit 60 is 2-6 feet. In one embodiment, spiral conduit 60 is 4 feet in length. FIG. 5 shows a cut-away view of injector body 58 and spiral conduit 60 in molded body 32. Fitting 40 is coupled to an upper end 61 of spiral conduit 60. Fitting 48 is coupled to a lower end 63 of spiral conduit 60. Accordingly, the air drawn from PCV 46 through fitting 40 travels the 2-6 foot length of spiral conduit 60 and exits through fitting 48 to intake manifold 20.

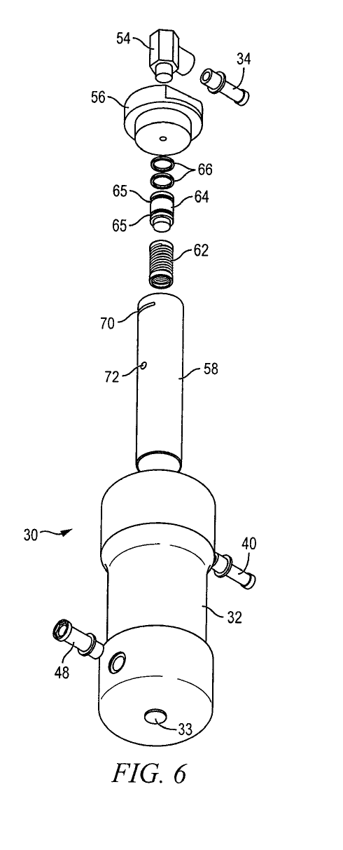

FIG. 6 is an exploded, perspective view of the components of fuel vaporizing device 30. A steel compression spring 62 is placed adjacent to and contacting a lower end of injector piston 64. The compression rating of spring 62 is selected depending on the factory specified fuel pressure and selected vacuum pressure. In one embodiment, the compression rating of spring 62 is selected for 40 PSI fuel pressure and 15-20 PSI vacuum pressure. The injector piston 64 is molded with slots 65 for placement of o-rings 66. O-rings 66 are placed in slots 65 around injector piston 64 for fluid-tight and air-tight seal between the fluid-state fuel and vacuum. In one embodiment, o-rings 66 are Viton-type rings rated for extreme temperatures ranging from −26° C. to +205° C. Alternatively, flex fuel vehicles use ethylene propylene (EPDM) type o-ring rated for −57° C. to +205° C. The spring piston assembly 68 is then placed in cavity 69 of injector body 58.

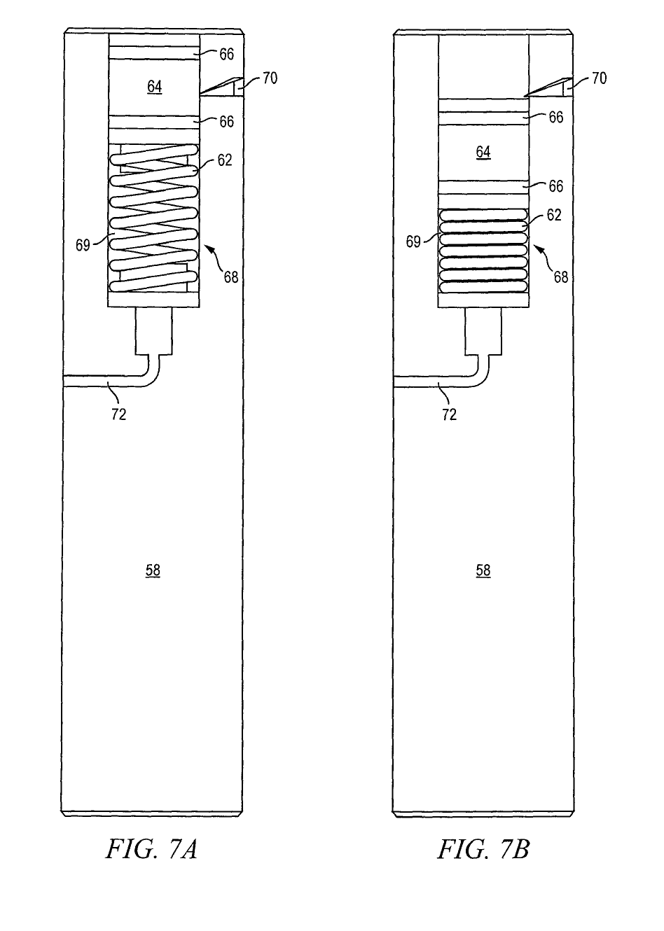

The injector body 58 with spring piston assembly 68 is disposed within spiral conduit 60 for a compact design, as shown in FIG. 7A. The 40 PSI fuel pressure plus the vacuum drawn through fitting 40 (from PCV 46) and inlet 72 (from spiral conduit 60) compresses spring 62 and pulls down on injector piston 64, as shown in FIG. 7B. The fuel flows through right-angle coupling 54 and body cap 56 to injector outlet 70. The HPLV flow control stabilizes injector piston 64 within injector body 58 for smooth transition between the open and closed states.

The injector outlet 70 atomizes the fuel, i.e., creates micro-size droplets. The atomized fuel enters spiral conduit 60 proximate to upper end 61 of the spiral conduit. As the fuel and air mixture travels the length of spiral conduit 60, the fuel and air mixture is converted to vaporized fuel. The vaporized fuel exits through fitting 48 and flows through hose 50 to intake manifold 20.

Fuel vaporizing device 30 increases fuel economy by converting fluid-state fuel from the fuel line into vaporized fuel which is fed into intake manifold 20. The vaporized fuel is routed to engine cylinder 24 for combustion. The exhaust manifold sensor detects the additional fuel and causes the engine controller to cut back on the fuel supplied by fuel injector 14. The vaporized fuel-air mixture coming from intake manifold 20 readily combusts within engine cylinder 24 to increase the percentage of fuel converted to actual work product and reduces the fuel supplied by fuel injector 14. The more fuel that can be supplied by fuel vaporizing device 30, the higher the combustion efficiency and greater the fuel economy. Fuel vaporizing device 30 is applicable to most gasoline engines, including those utilizing forced induction such as supercharged and turbo charged vehicles. Fuel vaporizing device 30 also controls flow of fuel under load or low vacuum conditions, e.g., less than 5 PSI, to restrict excess fuel from entering the intake track and causing rich conditions and surging.

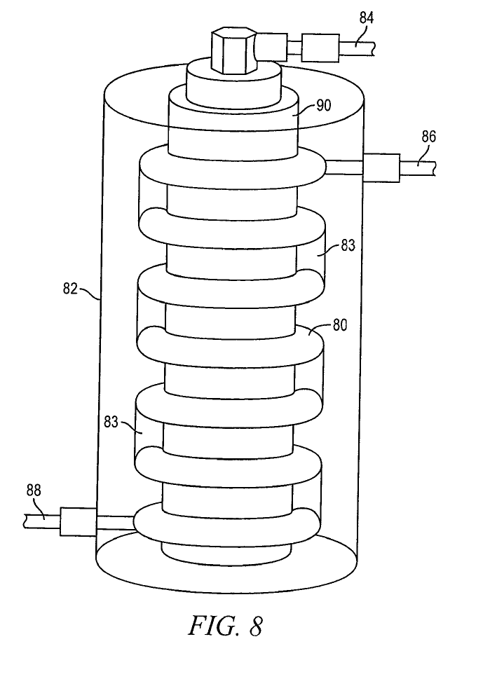

In another embodiment, FIG. 8 shows conduit 80 formed in molded cylindrical body 82 as a series of circular paths or rings interconnected by vertical conduit segments 83 on alternating sides of the molded body. The fuel line is connected to fitting 84; a vacuum line is connected to fitting 86; fitting 88 is connected to intake manifold 20. An injector body 90 is disposed within conduit 80 for atomizing the fuel, similar to FIG. 4. The atomized fuel is introduced into conduit 120. The interconnected circular paths create a length of the conduit for converting the atomized fuel and air to vaporized fuel, which is routed to the intake manifold.

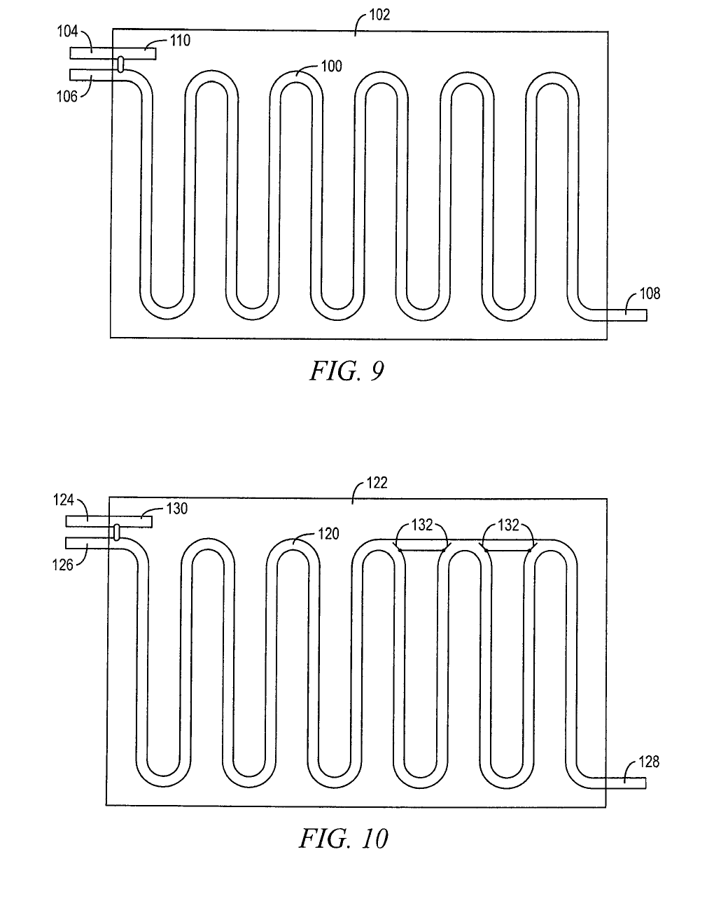

In another embodiment, FIG. 9 shows conduit 100 formed in molded rectangular body 102 in a serpentine arrangement. The fuel line is connected to fitting 104; a vacuum line is connected to fitting 106; fitting 108 is connected to intake manifold 20. An injector body 110 is disposed adjacent to conduit 100 for atomizing the fuel. The atomized fuel is introduced into conduit 120. The serpentine conduit has a length for converting the atomized fuel and air to vaporized fuel, which is routed to the intake manifold.

In another embodiment, FIG. 10 shows conduit 120 formed in molded rectangular body 122 in a serpentine arrangement. The fuel line is connected to fitting 124; a vacuum line is connected to fitting 126; fitting 128 is connected to intake manifold 20. An injector body 130 is disposed adjacent to conduit 120 for atomizing the fuel. The atomized fuel is introduced into conduit 120. The serpentine conduit has a length for converting the atomized fuel and air to vaporized fuel, which is routed to the intake manifold. Conduit 120 includes gates 132 which can be rotated to positions that vary the length of conduit 120. For example, closing a gate 132 bypasses a section of the conduit to shorten the conduit length. Gates 132 can be controlled by electrical or mechanical switching.

While one or more embodiments of the present invention have been illustrated in detail, the skilled artisan will appreciate that modifications and adaptations to those embodiments may be made without departing from the scope of the present invention as set forth in the following claims.

What is claimed is:

1. A fuel vaporizing device, comprising:
a body having a fuel inlet, air inlet, and vapor outlet;
a spiral conduit formed in the body, the spiral conduit having a first end coupled to the air inlet and second end coupled to the vapor outlet; and
an injector assembly disposed within the body and coupled to the fuel inlet, the injector assembly introducing atomized fuel into the first end of the spiral conduit, the atomized fuel being converted to vaporized fuel through a length of the spiral conduit from the first end to the second end of the spiral conduit, the vaporized fuel exiting the body at the vapor outlet.

2. The fuel vaporizing device of claim 1, wherein the injector assembly includes:
an injector body;
a compression spring disposed in a cavity of the injector body;
an injector piston disposed in the cavity of the injector body contacting the compression spring; and
an injector outlet for introducing the atomized fuel into the first end of the spiral conduit when the injector piston is displaced against the compression spring by pressure at the fuel inlet and pressure at the air inlet.

3. The fuel vaporizing device of claim 2, wherein the injector assembly further includes an o-ring disposed around the injector piston.

4. The fuel vaporizing device of claim 1, wherein the fuel inlet receives fluid-state fuel and the air inlet receives a vacuum.

5. The fuel vaporizing device of claim 1, wherein the body further includes an access port for removing fuel contaminants.

6. The fuel vaporizing device of claim 1, further including a fuel heater and pressure boost coupled to the fuel inlet.

7. The fuel vaporizing device of claim 1, wherein the spiral conduit has a length of 2-6 feet.

8. A fuel vaporizing device, comprising:
a body having a fuel inlet, air inlet, and vapor outlet;
a conduit formed in the body, the conduit having a first end coupled to the air inlet and second end coupled to the vapor outlet; and
an injector assembly disposed within the body and coupled to the fuel inlet, the injector assembly introducing atomized fuel into the first end of the conduit, the atomized fuel being converted to vaporized fuel through a length of the conduit from the first end to the second end of the conduit, the vaporized fuel exiting the body at the vapor outlet.

9. The fuel vaporizing device of claim 8, wherein the injector assembly includes:
an injector body;
a compression spring disposed in a cavity of the injector body;
an injector piston disposed in the cavity of the injector body contacting the compression spring; and
an injector outlet for introducing the atomized fuel into the first end of the conduit when the injector piston is displaced against the compression spring by pressure at the fuel inlet and pressure at the air inlet.

10. The fuel vaporizing device of claim 8, wherein the fuel inlet receives fluid-state fuel and the air inlet receives a vacuum.

11. The fuel vaporizing device of claim 8, wherein the conduit has a spiral arrangement or serpentine arrangement within the body.

12. The fuel vaporizing device of claim 8, wherein the conduit is arranged in a plurality of interconnected rings.

13. The fuel vaporizing device of claim 8, wherein the conduit has a selectable length.

14. The fuel vaporizing device of claim 13, wherein the conduit includes a plurality of gates which are opened or closed according to the selectable length.

15. The fuel vaporizing device of claim 8, wherein the conduit has a length of 2-6 feet.

16. A fuel vaporizing device, comprising:
a body having a fuel inlet, air inlet, and vapor outlet; and
a conduit formed in the body, the conduit having a first end coupled to the air inlet and second end coupled to the outlet, wherein fuel is introduced into the first end of the conduit and converted to vaporized fuel through a length of the conduit, the vaporized fuel exiting the body at the vapor outlet.

17. The fuel vaporizing device of claim 16, further including an injector assembly disposed within the body and coupled to the fuel inlet, the injector assembly introducing atomized fuel into the first end of the conduit, the atomized fuel being converted to vaporized fuel through a length of the conduit from the first end to the second end of the conduit, the vaporized fuel exiting the body at the vapor outlet.

18. The fuel vaporizing device of claim 17, wherein the injector assembly includes:
an injector body;
a compression spring disposed in a cavity of the injector body;
an injector piston disposed in the cavity of the injector body contacting the compression spring; and
an injector outlet for introducing the atomized fuel into the first end of the conduit when the injector piston is displaced against the compression spring by pressure at the fuel inlet and pressure at the air inlet.

19. The fuel vaporizing device of claim 16, wherein the fuel inlet receives fluid-state fuel and the air inlet receives a vacuum.

20. The fuel vaporizing device of claim 16, wherein the conduit has a spiral arrangement or serpentine arrangement within the body.

21. A method of making a fuel vaporizing device, comprising:
forming a body having a fuel inlet, air inlet, and vapor outlet;
forming a conduit in the body, the conduit having a first end coupled to the air inlet and second end coupled to the vapor outlet; and
disposing an injector assembly within the body and coupled to the fuel inlet, the injector assembly introducing atomized fuel into the first end of the conduit, the atomized fuel being converted to vaporized fuel through a length of the conduit from the first end to the second end of the conduit, the vaporized fuel exiting the body at the vapor outlet.

22. The method of claim 21, wherein the injector assembly includes:
providing an injector body;
disposing a compression spring in a cavity of the injector body;
disposing an injector piston in the cavity of the injector body contacting the compression spring; and
providing an injector outlet for introducing the atomized fuel into the first end of the conduit when the injector piston is displaced against the compression spring by pressure at the fuel inlet and pressure at the air inlet.

23. The method of claim 21, wherein the fuel inlet receives fluid-state fuel and the air inlet receives a vacuum.

24. The method of claim 21, wherein the conduit has a spiral arrangement or serpentine arrangement within the body.

25. The method of claim 21, wherein the conduit has a length of 2-6 feet.
